(19) United States
(12) Patent Application Publication
(10) Pub. No.: US 2017/0175428 A1
(43) Pub. Date: Jun. 22, 2017

(54) Bowtie Hinges

(71) Applicant: Plastek Industries, Inc., Erie, PA (US)

(72) Inventors: H Stephen Quinn, Eau Claire, WI (US); Peter A. Piscopo, Medford, NJ (US)

(73) Assignee: Plastek Industries, Inc., Erie, PA (US)

(21) Appl. No.: 15/116,329

(22) PCT Filed: Feb. 5, 2015
(86) PCT No.: PCT/US2015/014568

§ 371 Date: Aug. 3, 2016

Related U.S. Application Data
(60) Provisional application No. 61/935,927, filed on Feb. 5, 2014.

(51) Int. Cl. E05D 1/02; B65D 47/08; B65D 43/16; E05D 1/04

(52) U.S. Cl. CPC E05D 1/02; E05D 1/04; B65D 47/0809; B65D 43/166; E05Y 2900/602; B65D 2543/00101

(57) ABSTRACT

A closure system (200; 300; 400; 500; 600) comprises the unitarily molded single piece combination of: a first portion (204; 304; 404; 504; 604); a living hinge (202; 302; 402; 502; 602); and a second portion (206; 306; 406; 506; 606) coupled by the living hinge to the first portion and shiftable between a first condition and second condition via rotation about the living hinge. The living hinge comprises a first end (80) at the first portion and a second end (82) at the second portion. Between the first end and the second end, the hinge comprises: a central portion; first and second lateral portions; a first face (88); and a second face (90), at least one of the first face and the second face bearing a plurality of ribs (220, 222; 320; 430, 432, 434; 530, 534; 620).

### CROSS-REFERENCE TO RELATED APPLICATION

Benefit is claimed of U.S. patent application Ser. No. 61/935,927, filed Feb. 5, 2014, and entitled “Bowtie Hinges”, the disclosure of which is incorporated by reference herein in its entirety as if set forth at length.

### BACKGROUND

The invention relates to packaging. More particularly, the invention relates to living hinges for molded package closures.

A well-developed art exists in molded plastic living hinges. Key examples involve consumer goods packaging such as caps for bottles, dispensing tubes, jars, tubs and the like. Exemplary situations involve a closure formed as the unitary molding of a base for securing to a container body, a closure member (e.g., a cover) for opening and closing relative to the base, and a hinge connecting the base and the closure member to guide movement between closed and open conditions. A variety of such closures have been proposed. One example of a snap hinge closure is found in U.S. Pat. No. 5,143,234 of Lohrman et al.

PCT/US2011/053858 discloses yet further living hinge configurations.

### SUMMARY

One aspect of the disclosure involves a system comprising the unitarily molded single-piece combination of: a first portion; a living hinge; and a second portion coupled by the living hinge to the first portion and shiftable between a first condition and second condition via rotation about the living hinge. The living hinge comprises a first end at the first portion and a second end at the second portion. Between the first end and the second end, the hinge comprises: a central portion; first and second lateral portions; a first face; and a second face, at least one of the first face and the second face bearing a plurality of ribs.

In one or more embodiments of any of the foregoing embodiments, the plurality of ribs may provide means for stiffening the hinge.

In one or more embodiments of any of the foregoing embodiments, the plurality of ribs include one or more ribs spanning a junction with at least one of the first portion and the second portion.

In one or more embodiments of any of the foregoing embodiments, the one or more ribs comprise a first plurality spanning a junction with the first portion and a second plurality spanning a junction with the second portion, the first and second pluralities being staggered relative to each other.

In one or more embodiments of any of the foregoing embodiments, the lateral portions have curvature between the first and second ends opposite a curvature of the central portion.

In one or more embodiments of any of the foregoing embodiments, the first portion is a mounting base having an aperture; the second portion is a cap; the first condition is a closed condition; the second condition is an open condition.

In one or more embodiments of any of the foregoing embodiments, spring bias of the living hinge will maintain the hinge in the open condition

In one or more embodiments of any of the foregoing embodiments, the base is internally threaded; the cap, in the closed condition, surrounds and covers an upper rim portion of the base and has a detented engagement therewith.

In one or more embodiments of any of the foregoing embodiments, the second condition is a relaxed condition; and the combination is molded of polypropylene.

In one or more embodiments of any of the foregoing embodiments, in the as-molded condition, a proximal-to-distal median of the hinge is generally upwardly concave and downwardly convex along the central portion.

In one or more embodiments of any of the foregoing embodiments: in a closed condition the first face is generally concave in sagittal section and the second face is generally convex in said sagittal section; in an open condition the first face is generally convex in transverse vertical section and the second face is generally concave in said transverse vertical section; and in the open condition, the central portion is asymmetrically oriented relative to the base and closure member.

In one or more embodiments of any of the foregoing embodiments, in an as-molded condition the first end and second end are vertically offset from each other.

In one or more embodiments of any of the foregoing embodiments, in an as-molded condition, the central portion is off-symmetric by 5° to 25°.

In one or more embodiments of any of the foregoing embodiments, the plurality of ribs are on an underside one of the first face and the second face but not the other face.

Another aspect of the disclosure involves a closure comprising the unitarily molded single-piece combination of: a base having an opening; a living hinge; and a closure member coupled by the living hinge to the base and shiftable between a closed condition and an open condition via rotation about the living hinge. The living hinge comprises: a first end at the base; a second end at the closure member; a central portion; first and second lateral portions; a first face; and a second face. In the closed condition the first face is generally concave in sagittal section and the second face is generally convex in said sagittal section. In the open condition the first face is generally convex in transverse vertical section and the second face is generally concave in said transverse vertical section. In the open condition, the central portion is asymmetrically oriented relative to the base and closure member.

In one or more embodiments of any of the foregoing embodiments, in an as-molded condition the first end and second end are vertically offset from each other.

In one or more embodiments of any of the foregoing embodiments, in an as-molded condition, the central portion is off-symmetric by 5° to 25°.

In one or more embodiments of any of the foregoing embodiments, in the as-molded condition, a proximal-to-distal median of the hinge is generally upwardly convex along a central portion.

In one or more embodiments of any of the foregoing embodiments, a method for manufacturing the system comprises injection molding in the as-molded condition.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a view of a prior art closure in an as-molded open condition/orientation.

FIG. 1A is an enlarged view of a hinge region of the closure of FIG. 1.

FIG. 2 is a top view of the hinge of the closure of FIG. 1.

FIG. 3 is a central transverse vertical sectional view of the hinge taken along line 3-3 of FIG. 2.

FIG. 4 is an end view of the hinge.

FIG. 5 is a medial sectional view of the hinge taken along line 5-5 of FIG. 2.

FIG. 6 is an off-center transverse sectional view of the hinge taken along line 6-6 of FIG. 2.

FIG. 7 is a top perspective view of a second closure in an open as-molded condition.

FIG. 8 is a bottom perspective view of the second closure.

FIG. 9 is a top view of the second closure.

FIG. 10 is a bottom view of the second closure.

FIG. 11 is a side view of the second closure.

FIG. 12 is a medial sectional view of the second closure taken along line 12-12 of FIG. 9.

FIG. 13 is a bottom perspective view of a third closure.

FIG. 14 is a side view of the third closure.

FIG. 15 is a bottom view of the third closure.

FIG. 16 is a central vertical transverse sectional view of the third closure taken along line 16-16 of FIG. 15.

FIG. 17 is an off-center transverse sectional view of the third closure taken along line 17-17 of FIG. 15.

FIG. 17A is an enlarged view of a lateral portion of a hinge of the third closure of FIG. 17.

FIG. 18 is a medial sectional view of the third closure taken along line 18-18 of FIG. 15.

FIG. 19 is a sagittal sectional view of the third closure taken along line 19-19 of FIG. 15.

FIG. 20 is an end view of the third closure with its hinge shown in broken lines.

FIG. 21 is a sagittal sectional view of the third closure taken along line 20-20 of FIG. 15.

FIG. 22 is a bottom perspective view of a fourth closure.

FIG. 22A is an enlarged view of the fourth closure of FIG. 22.

FIG. 23 is a top view of the fourth closure.

FIG. 24 is a side view of the fourth closure.

FIG. 25 is a medial sectional view of the fourth closure taken along line 25-25 of FIG. 23.

FIG. 26 is central transverse vertical sectional view of the fourth closure taken along line 26-26 of FIG. 23.

FIG. 26A is an enlarged view of a lateral portion of a hinge of the fourth closure of FIG. 26.

FIG. 27 is a bottom view of a fifth closure.

FIG. 28 is a top perspective view of the fifth closure.

FIG. 29 is a bottom perspective view of the fifth closure.

FIG. 29A is an enlarged view of a portion of the fifth closure of FIG. 29.

FIG. 30 is a medial sectional view of the fifth closure taken along line 30-30 of FIG. 27.

FIG. 30A is an enlarged view of a hinge portion of the fifth closure of FIG. 30.

FIG. 31 is a central transverse sectional view of the fifth closure taken along line 31-31 of FIG. 27.

FIG. 31A is an enlarged view of a lateral portion of the fifth closure of FIG. 31.

FIG. 32 is a bottom perspective view of a sixth closure.

FIG. 33 is a side view of the sixth closure.

FIG. 34 is a top view of the sixth closure.

FIG. 35 is a bottom view of the sixth closure.

FIG. 36 is an off-center transverse vertical sectional view of the sixth closure taken along line 36-36 of FIG. 35.

FIG. 36A is an enlarged view of a lateral portion of a hinge of the sixth closure.

FIG. 37 is a medial sectional view of the sixth closure taken along line 37-37 of FIG. 36.

FIG. 37A is an enlarged view of the hinge of the sixth closure.

Like reference numbers and designations in the various drawings indicate like elements.

### DETAILED DESCRIPTION

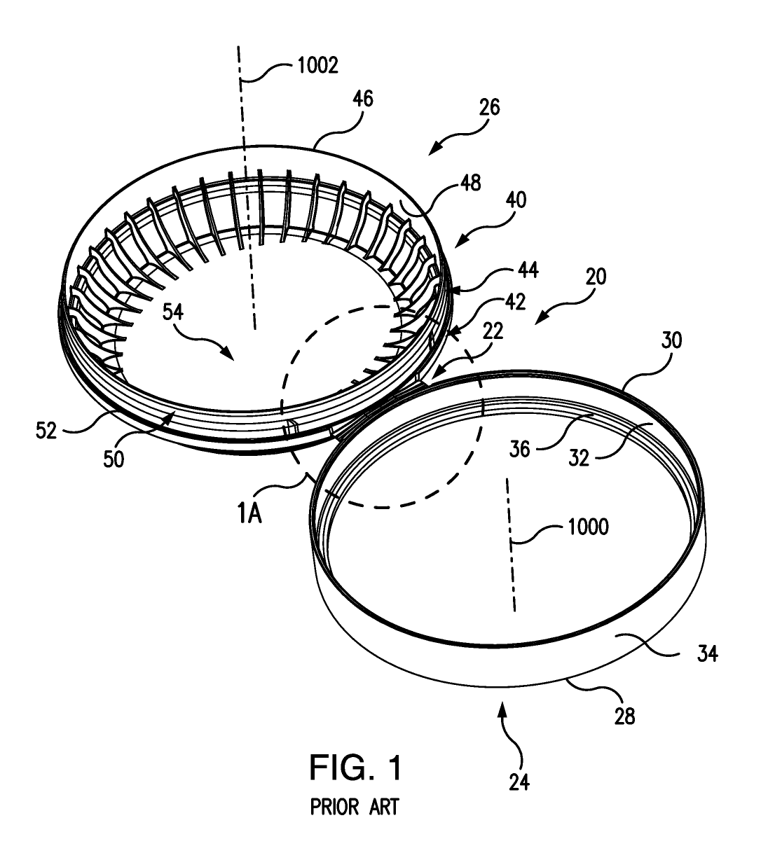

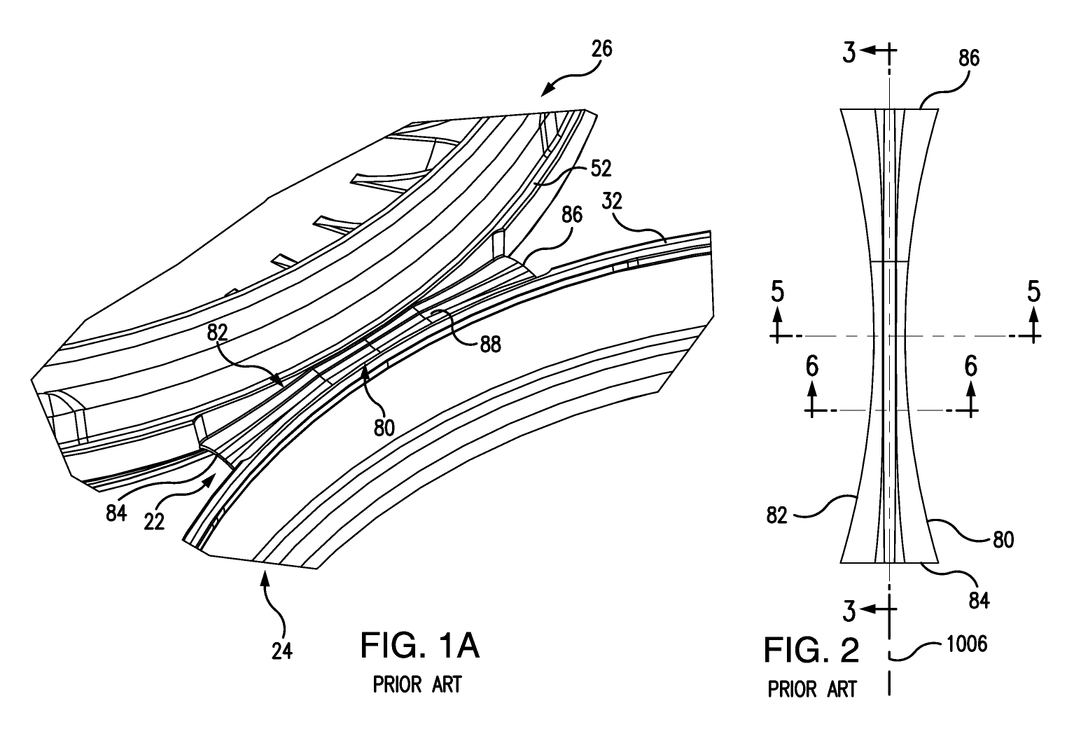

FIG. 1 shows a prior art closure system 20 in an open condition. The illustrated exemplary system 20 comprises a unitarily molded combination comprising a living hinge 22 coupling a first portion 24 to a second portion 26. The exemplary first portion is a fixed portion such as a mounting base or “frame”. The exemplary mounting base 24 is formed as an essentially fully open ring or frame structure. The exemplary base 24 comprises a sidewall extending from a lower end formed by a lower rim 28 to an upper end formed by an upper rim 30 and has an inner/inboard/interior surface 32 and an outer/outboard/exterior surface 34. The inner surface 32 may bear a feature 36 such as a thread or an annular bead for respectively screwing onto or snapping onto a neck of a mating container body (not shown) and securing to a complementary feature thereon. Although the exemplary rim 30 defines a mouth that is essentially fully open, alternative implementations may have a smaller opening such as defined along a web extending radially inward from the upper end of the sidewall. The exemplary frame has a central vertical axis 1000 (vertical and longitudinal from the point of the container mouth).

Other possible mounting include adhesive mounting, solvent bond mounting, thermal weld mounting and like.

The exemplary second portion 26 is a closure member or element. The closure member 26 is articulatable by flexing of the hinge 22 relative to the base 24 when in a closed condition and one or more open conditions.

The exemplary closure member 26 is formed as a cover, more particularly, a combination of cap and plug. The closure member has a sidewall 40 having an upper (when closed on an upright package) portion 42 and an inwardly rebated lower portion 44. The lower portion extends upward from a lower rim 46. The sidewall has an inner surface 48 and an outer surface 50. Along the lower portion 44 the outer surface 50 is dimensioned to be received within an upper portion of the base 24. The upper portion 42 forms a shoulder 52 at junction with the lower portion 44 along the outer surface 50. In the exemplary implementation, the shoulder 52 is positioned to closely face or contact the upper rim 30 in the closed condition.

The exemplary closure element 26 further includes a transverse web 54 forming a top of the closure member. The surface 50 along the lower portion 44 and mating surface 32 may bear cooperating detent moieties (e.g., rib and channel or rib pairs) for detenting the closure element in the closed condition. Yet other locking features may include latches or the like.

FIG. 1A shows further details of the hinge 22.

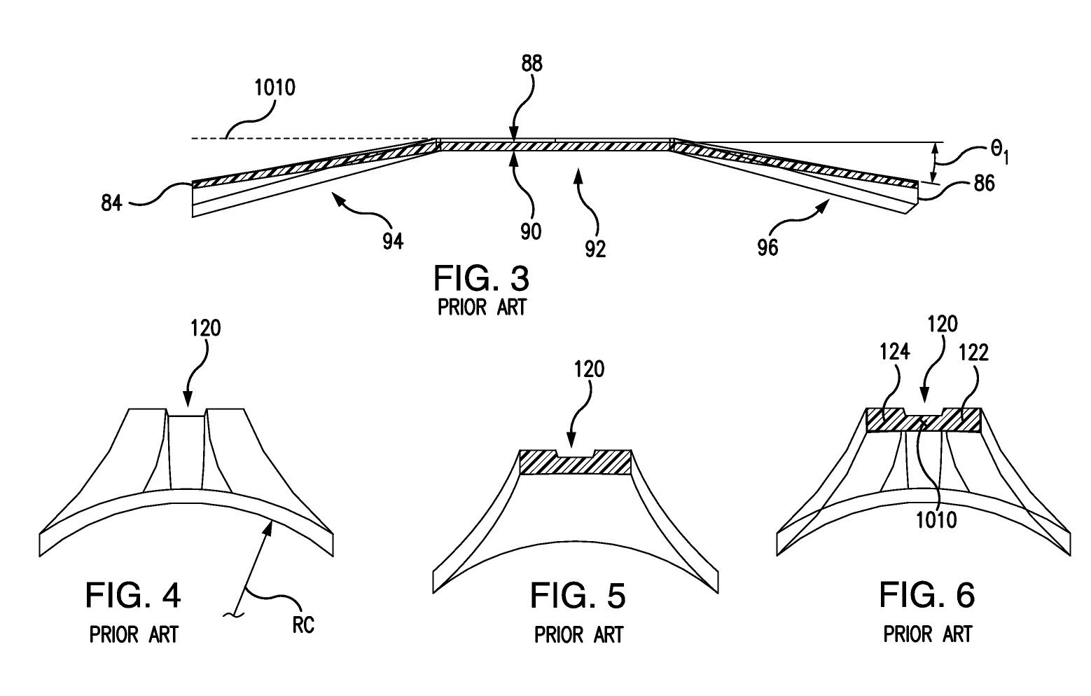

The exemplary living hinge 22 is un-slitted and extends continuously from a first (proximal) end 80 at the base to a second (distal) end 82 at the cap. The exemplary hinge has a left edge 84 and a right edge 86. For convenient reference in not limiting any use, left and right are viewed from the perspective of a viewer looking across the base 24 toward the hinge 22 from slightly above. The exemplary hinge has a first (inboard) face 88 and a second (outboard) face 90 (FIG. 3). The exemplary hinge has three portions or sections distributed laterally: a central portion 92; a left portion 94; and a right portion 96. In the as-molded condition (which corresponds to one open condition but not necessarily a relaxed open condition) transverse cross-sections of the hinge and its portions 92, 94, and 96 are essentially straight. The portions 94 and 96 have proximal ends at junctions with adjacent ends of the central portion 92 and extend downward to the distal ends or edges 84 and 86 mentioned above. The exemplary downward angle is shown as θ₁ (FIG. 3) along a transverse central vertical plane 1006 (FIG. 2). Due to the curvature of the exemplary base 24 and closure member 26, the angle increases away from the plane 1006. Exemplary θ₁ is approximately 9° along the plane 1006 increasing to approximately 15° at the edges 80 and 82. Along the portions 94 and 96, the underside 90 is downwardly concave in longitudinal vertical section (FIGS. 4-6). The central portion 92 is of none or lesser curvature. The exemplary central portion comprises a transverse channel 120 to provide flexibility about a hinge axis 1010 (shown schematically and potentially shifting slightly during flexing).

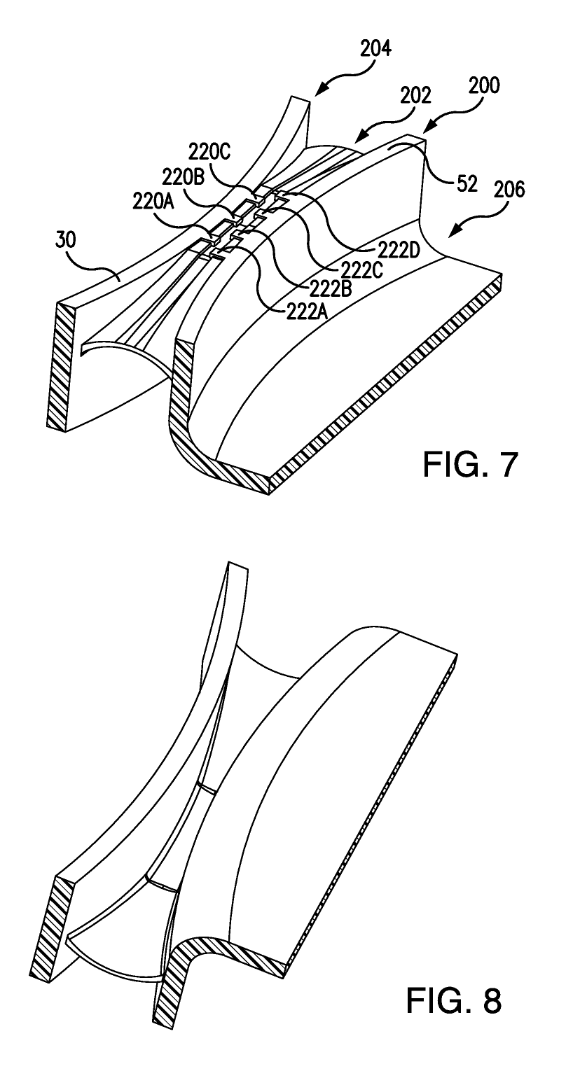

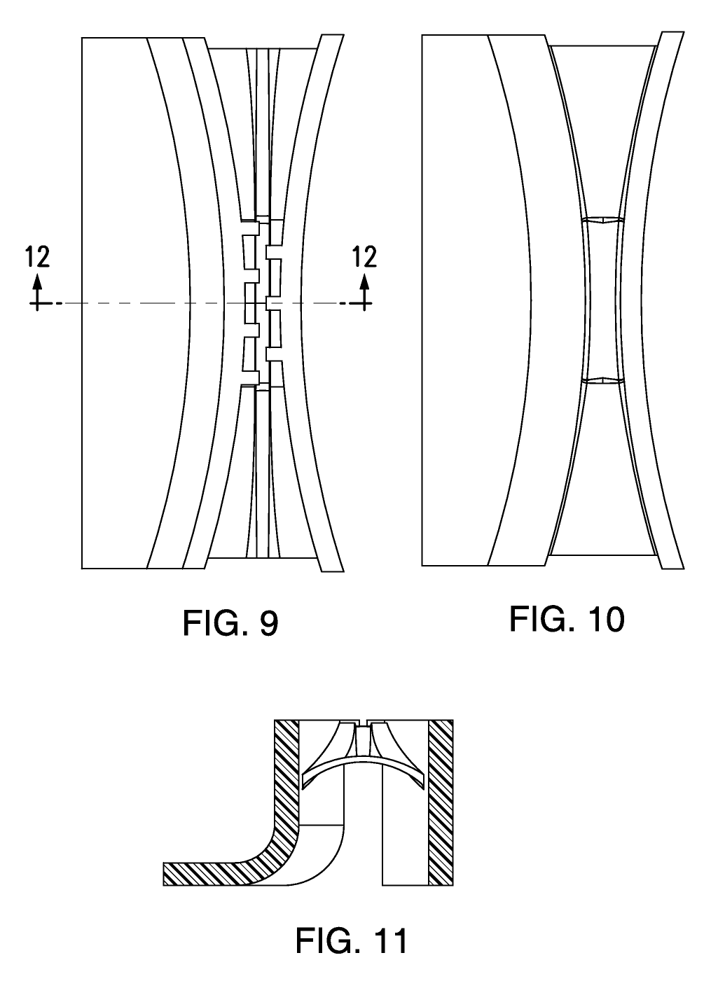

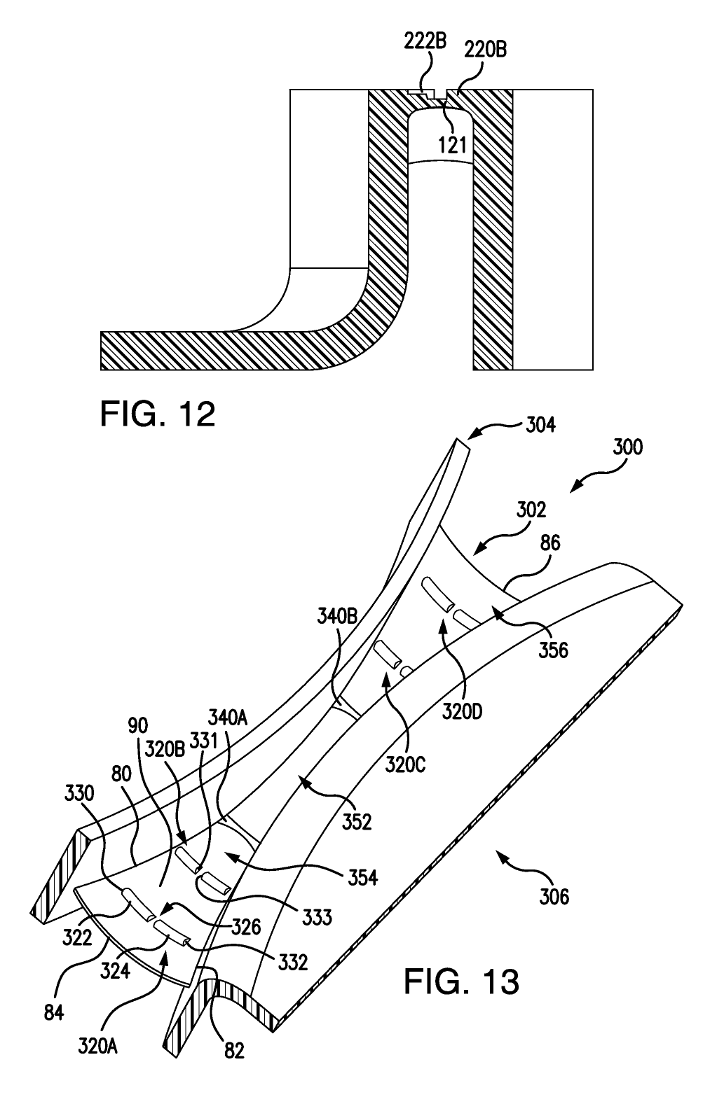

FIG. 7 shows a closure 200 comprising a hinge 202 between a base 204 and a closure member 206. Except for a modification to the hinge, these and their associated features may be similar to the closure 20 of FIG. 1. For ease of illustration, however, the closure member 206 is shown as a mere cover with rim-to-rim mating (e.g., the shoulder 52 of FIG. 1 is now the rim mating with the rim 30).

A difference between the hinge 202 and the hinge 22 is the presence of reinforcements 220A-220C (collectively and individually 220) and 222A-222D (collectively and individually 222). Exemplary reinforcements are positioned along the central portion 92. More particularly, they are essentially localized to the central portion. The exemplary reinforcements are along the upper surface 88. The exemplary reinforcements extend inward (toward the transverse vertical centerplane of the hinge) from the associated base 204 or closure member 206, more particularly, along the respective portions 122 and 124 on opposite sides of the thinned portion 121 formed at the base of the channel 120. More particularly, the reinforcements extend slightly onto the thinned portion 121. The exemplary two sets of reinforcements are staggered relative to each other (e.g., exactly out of phase with each other) so that a reinforcement from one group faces a gap between reinforcements of the other group.

The effect of the reinforcements 220 and 222 is to isolate the hinge axis to ensure alignment during closing. The out-of-phase arrangement avoids reinforcements colliding with each other which would cause a bulge in the closed hinge. It also gives a unique appearance.

FIG. 13 shows a closure 300 having a hinge 302 connecting a frame 304 to a closure member 306 in similar fashion to those of the closure 200.

A characteristic difference between the closures 300 and 200 involves the nature of reinforcements. The closure 300 has reinforcements along the hinge underside or outboard surface 90 rather than the upper or inboard surface 88. Exemplary reinforcements are shown as 320A-320D (collectively and individually 320) arrayed between the edges 84 and 86. Each exemplary reinforcement 320 is segmented. More particularly, each exemplary reinforcement is formed in two segments 322 and 324 separated by a gap 326. Each reinforcement is longitudinally elongate extending partially between the ends 80 and 82. In the exemplary embodiment, each reinforcement has outboard terminal ends 330, 332 spaced apart from the adjacent edge 80 or 82, respectively and inboard terminal ends 331, 333 spaced apart from each other by the gap 326. The exemplary reinforcements are of arcuate, convex-downward cross-section (e.g. slightly less than semi-circular). The exemplary heights/thicknesses of the segments 322, 324 taper towards their ends with the curvature increasing in magnitude (radius of curvature) so as to flatten towards the ends. For example, the FIG. 17A cross-section cuts through the segments 322 but one sees the terminal ends 332 of the segments 324 due to the curvature of the section 354. FIG. 21 also shows the tapering.

FIG. 13 further shows rounds/blends 340A and 340B (collectively and individually 340) between center portion 352 on the one hand and lateral portions 354, 356 on the other hand. These provide a smoother transition between the differing curvatures of the main sectors.

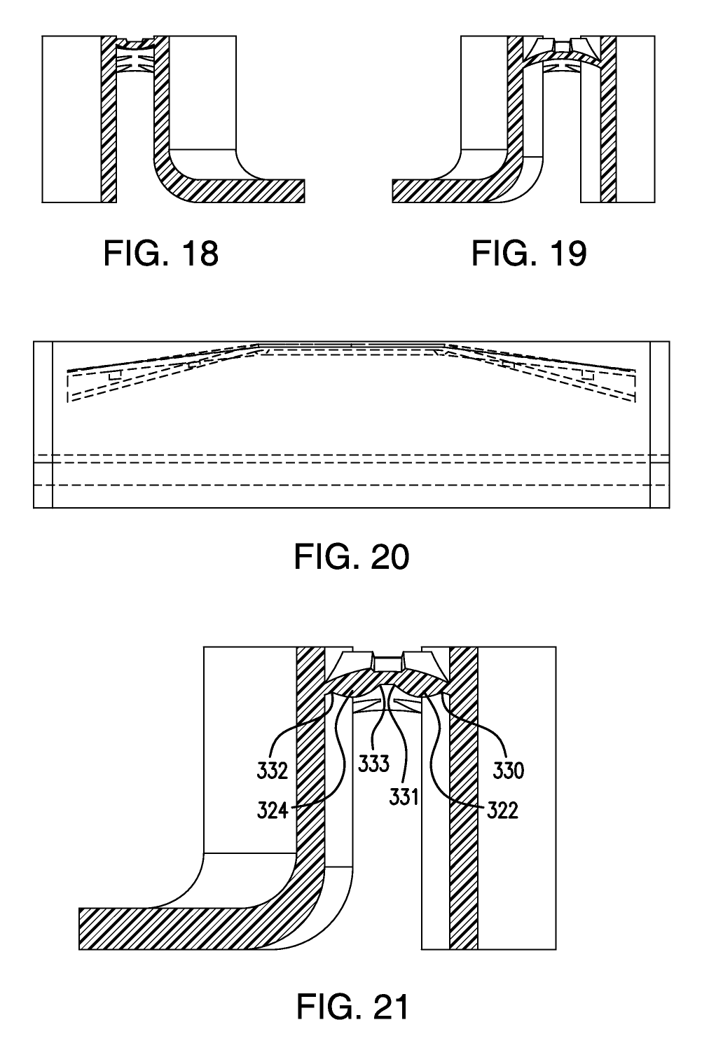

A further difference between the closure 300 and the closure 200 involves the shape of the center portion 352 relative to the lateral portions 354 and 356 when compared with the corresponding portions 92, 94 and 96. The exemplary portions 354 and 356 have similar downward longitudinal concavity in overall section and along their undersides (the associated portions of the underside 90). The central portion 352, however, has a downward convexity of an overall cross-section and along its underside (i.e., the concavity or convexity reverses between the lateral portions on the one hand (downward concavity in FIG. 1A) and the central portion on the other hand (downward convexity in FIG. 18)). The change in concavity/convexity may serve to resist fatiguing in the closed condition. Specifically, the molded plastic may tend to take a set in its closed condition. Thus, upon opening, the closure may only open to a neutral condition rotated approximately 110° to 135° from the closed condition rather than the full 180° to the as-molded condition. The concavity change may impart greater local strains which, even with the fatigue, neutralize at closer to the 180° as-molded condition.

There may synergy between the convexity change and the reinforcements in that the reinforcements stretch in the closed condition and take increased strain, thereby, also helping the closure to initially pop open to a neutral condition closer to the 180° as-molded condition. For example, exemplary rotation from the closed condition may be in excess of 135°, more particularly, in excess of 145° or in excess of 155°.

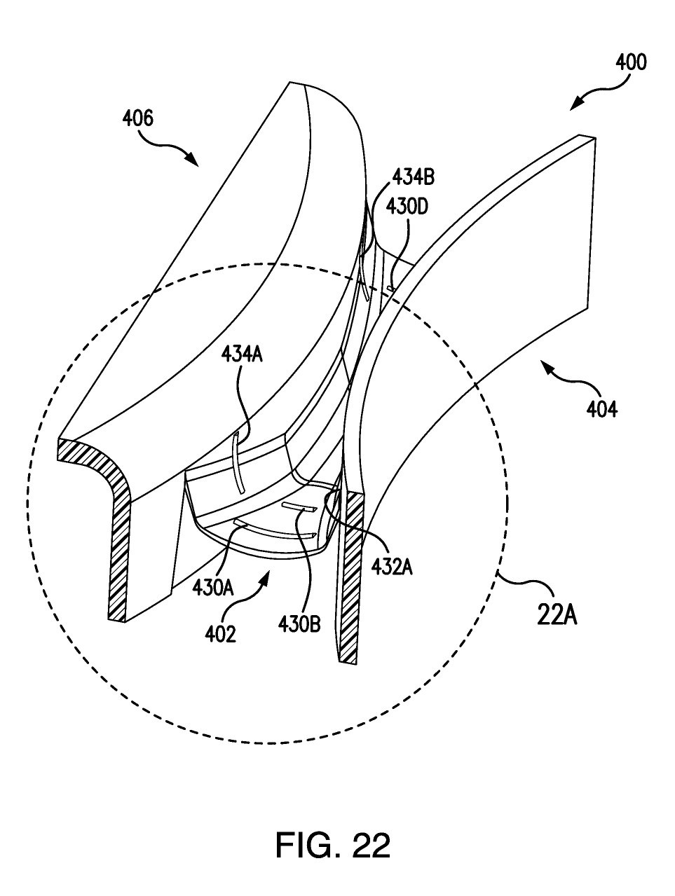

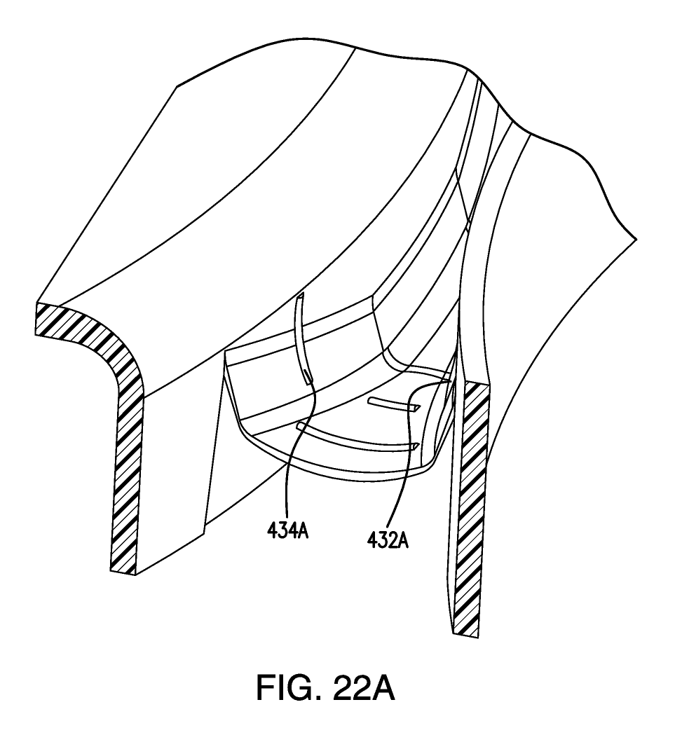

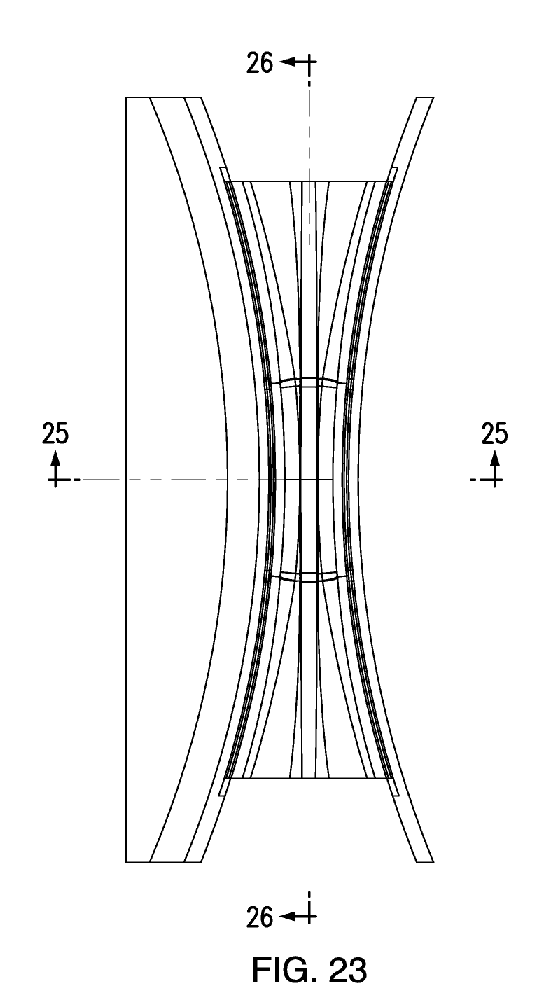

FIG. 22 shows a further closure 400 having a hinge 402 connecting a base 404 to a closure member 406. The closure 400 differs from the above closures in two notable ways which may be separately practiced or combined: the nature of reinforcements and the overall hinge geometry.

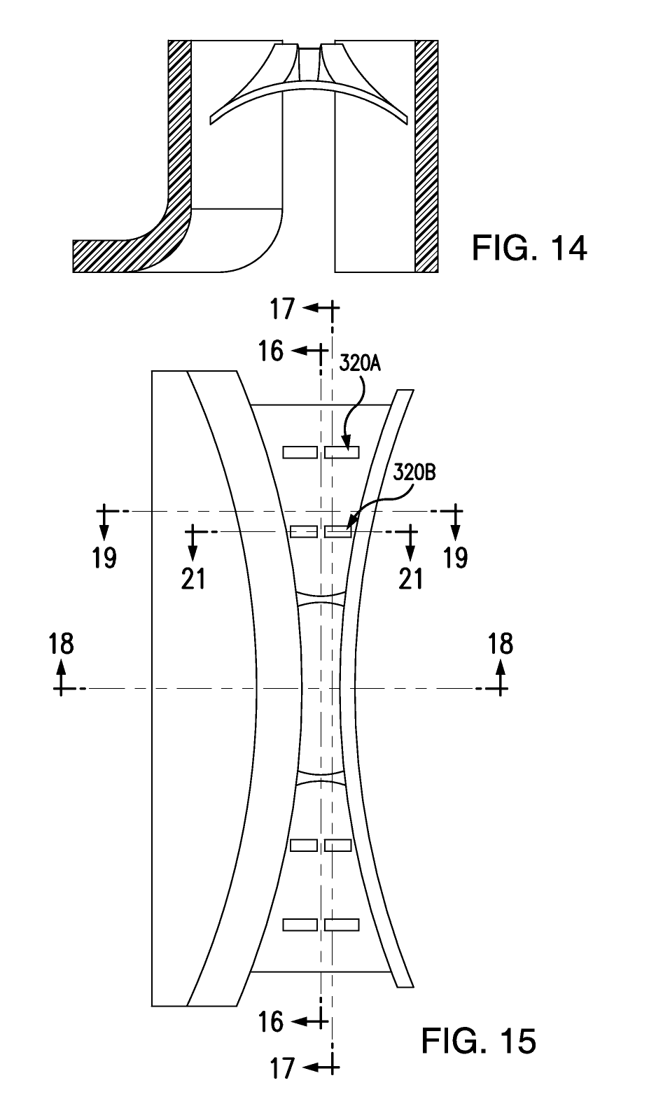

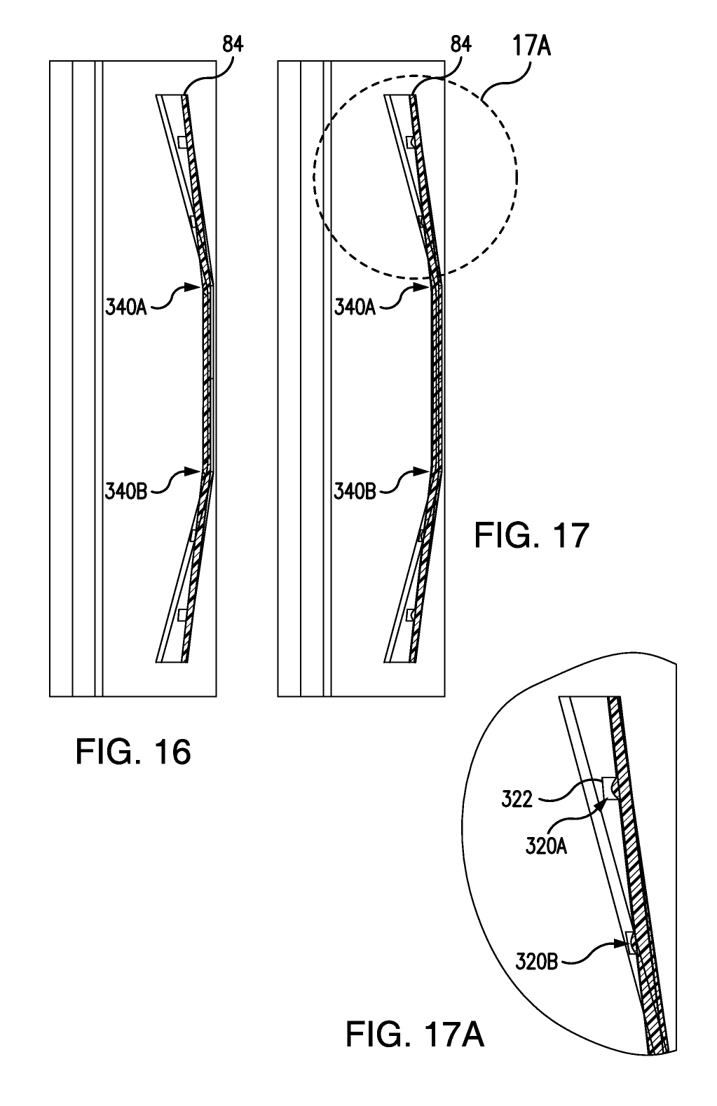

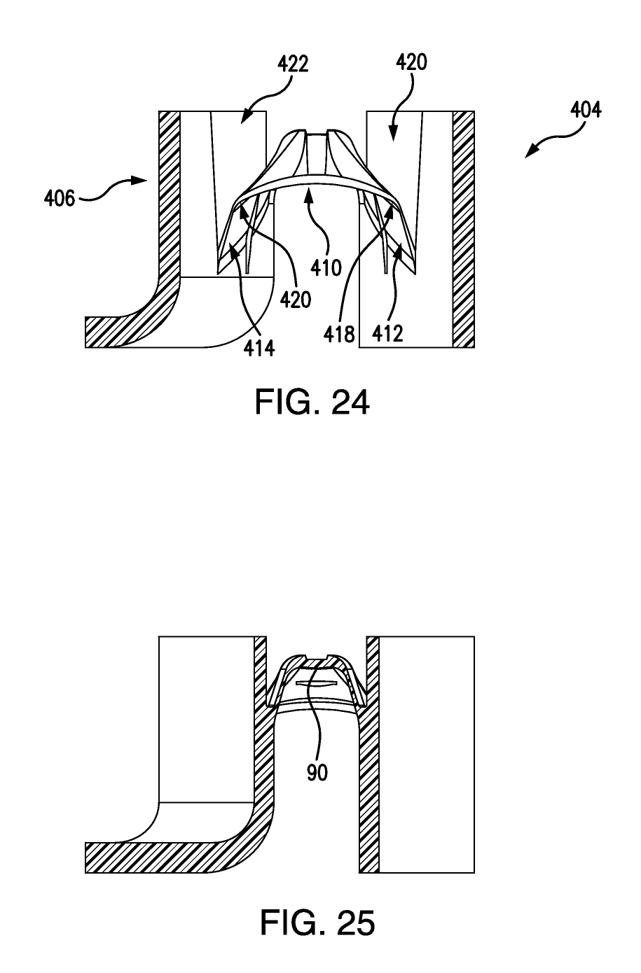

A first aspect of overall geometry is seen, for example, in comparing FIG. 24 with FIG. 14. The FIG. 14 example has a generally shallow single arc to its underside longitudinal section. The FIGS. 22 and 24 embodiment in longitudinal sectional profile, having a relative smooth and continuously curving longitudinally central portion 410 but then have longitudinally outboard portions 412 and 414 (FIG. 4) respectively joining the base 404 and closure member 406. There is a relatively tightly concave transition 418, 420 between this longitudinally central portion 410 and the portions 412 and 414 to provide a more channel-like section. The base and closure member also have relieved areas 420 and 422 which may partially accommodate the hinge in a closed condition of the closure.

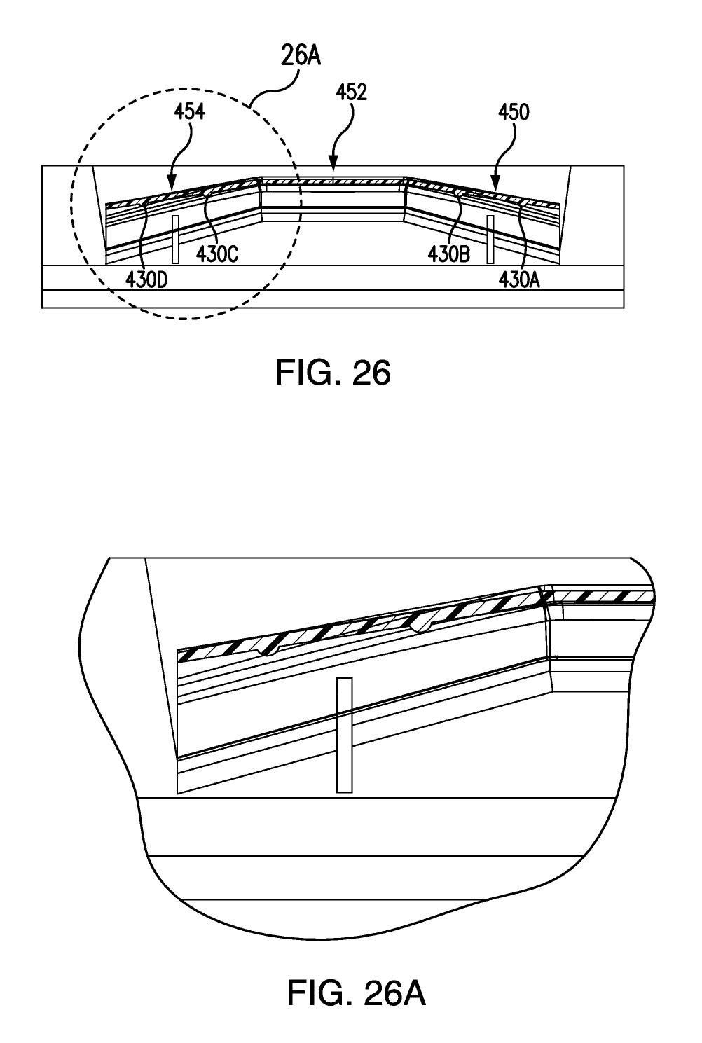

A second overall geometric difference which may be practiced together with or independently of the other differences is the nature of the longitudinal cross-section of the longitudinally central portion between: on the one hand, the laterally central portion 452 (FIG. 26); and on the other hand, (laterally outboard) the lateral portions 454 and 456. FIG. 25 shows the underside 90 along the longitudinally and laterally central inboard portion as being convex downward; whereas FIG. 24 shows the underside along the lateral portions of the longitudinally central portion 410 (alternately characterized as a longitudinally central portion of the lateral portions) being concave downward (FIG. 24).

A further difference is the nature of reinforcements. FIGS. 22 and 26 show two forms of reinforcement: reinforcements 430A-430D (collectively and individually 430); and reinforcements 432A, 432B, 434A, and 434B. The exemplary reinforcements 430 fall along the underside of the longitudinally central portion of the hinge, more particularly they fall along longitudinally central portions of the lateral portions. The reinforcements 432A and 434B (collectively and individually 432) fall along the underside of the longitudinally outboard portion 412 spanning over to a main portion of the base sidewall below a hinge root/edge. Similarly, 434A and 434B (collectively and individually 434) fall along the underside of the portion 414 spanning to a main outer surface of the sidewall of the closure member 406. The exemplary reinforcements are also localized on the lateral portions (e.g., one reinforcement 432 or 434 per each of the four lateral portions of the longitudinally outboard portions 412, 414).

In operation, the hinge 402 geometry functions to allow the hinge to lay relatively flat in the closed condition, thereby, presenting a neater appearance. For example, edges of the hinge in the closed condition do not protrude radially as much as they otherwise would. The reinforcement 430 serves to encourage snapping open to close to the as-molded condition (at least closer than would occur in the absence of the reinforcement 430) while the reinforcements 432 and 434 serve more to generally reinforce the hinge to stabilize it. The increased length of the cross-section of the hinge between base and closure member provides further flexibility or slop, making such reinforcement more important.

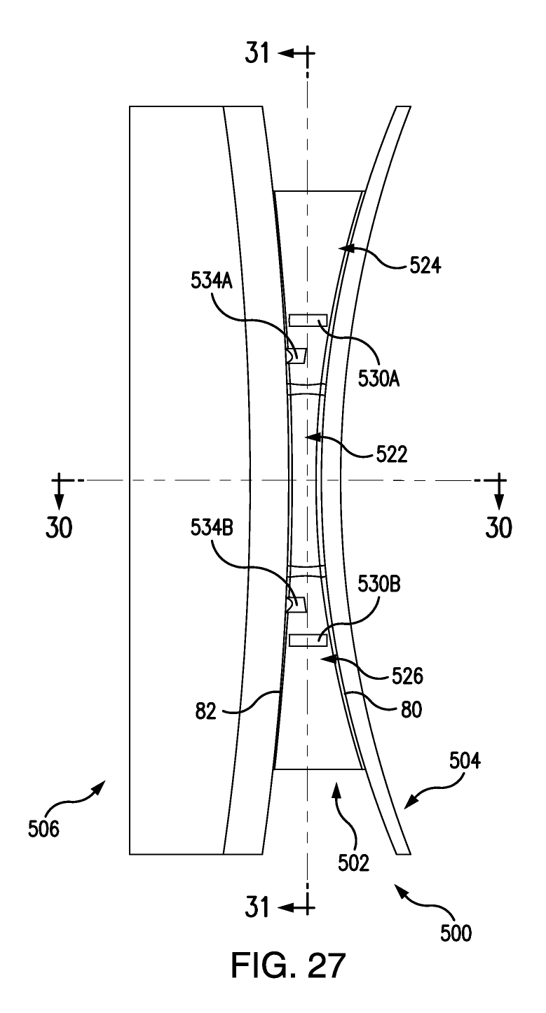

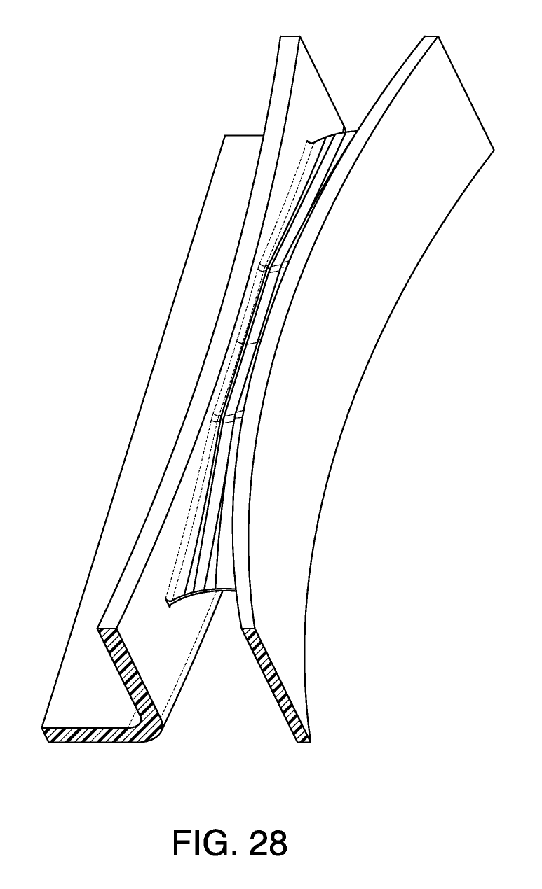

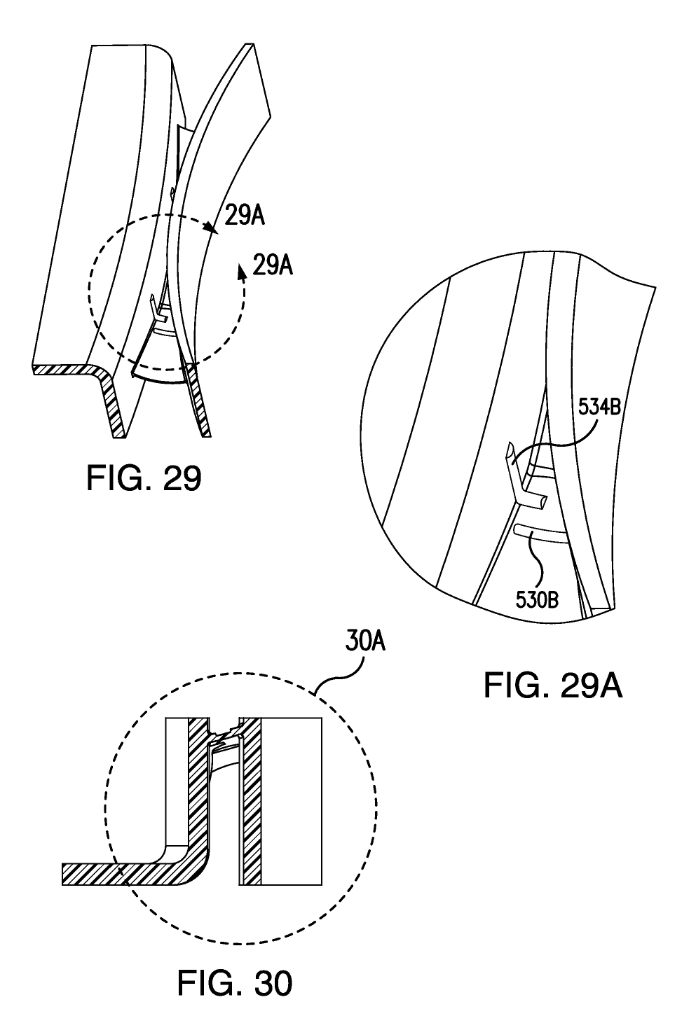

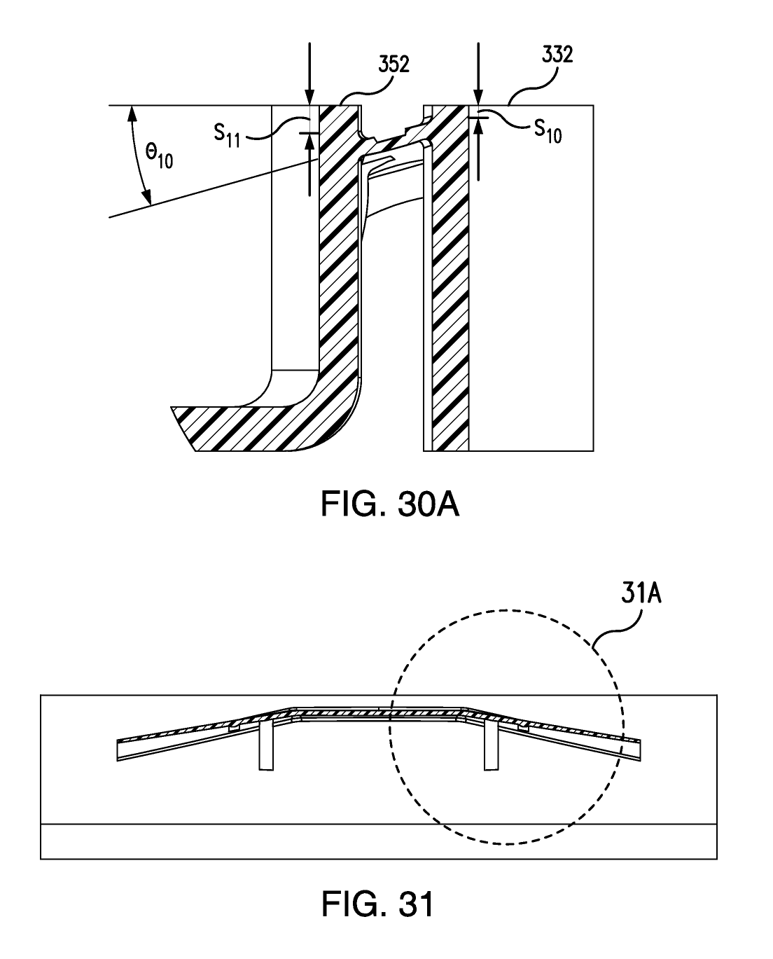

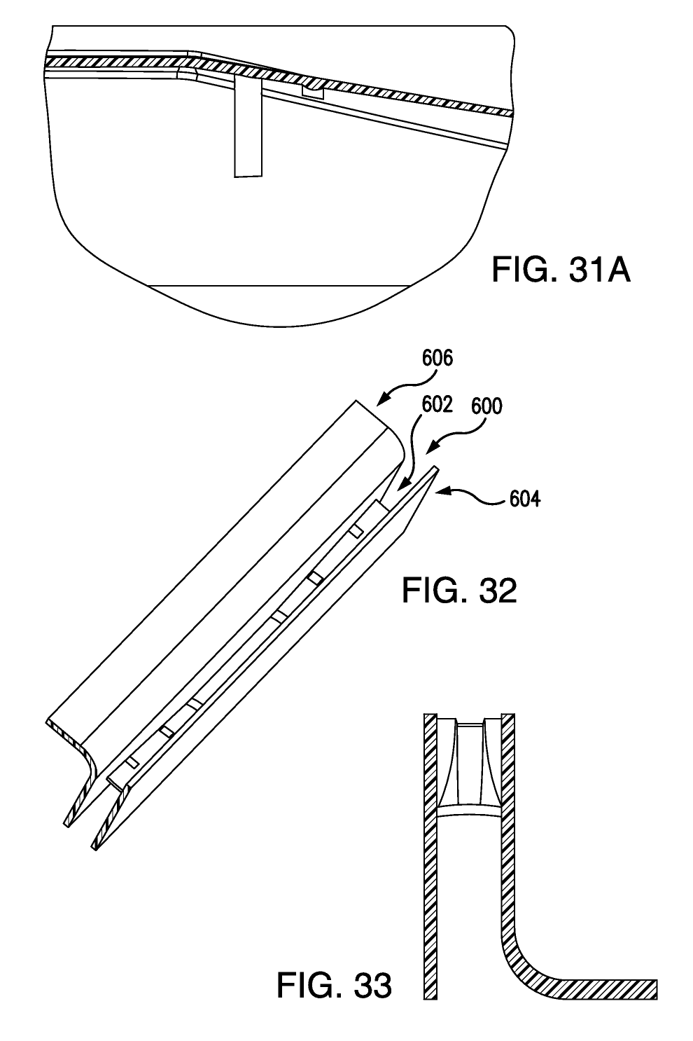

FIGS. 27-31 show a further closure 500 having a hinge 502 connecting a base 504 to a closure member 506. This hinge 502 may be of generally similar configuration to the other hinges described herein. The hinge however is tilted (e.g., by an angle θ₁₀ about a transverse horizontal axis so as to orient the hinge, and more particularly, its central portion, asymmetrically relative to the base and closure member. The exemplary closure 500 is based on the prior art system 20 of FIG. 1, however, other closures may form similar bases. Accordingly, various unnumbered features of this system may correspond to those of system 20 or other systems above. For example, although an embodiment is shown in U.S. patent application Ser. No. 61/935,927 lacking any reinforcement rib or the like, the presently illustrated example includes such features. The laterally central portion is shown as 522 and the laterally outboard portions or wings are shown as 524 and 526. Each of these has relatively thick longitudinally outboard portions and a relatively thin central portion when based on the FIG. 1 configuration. The central portion, however, in plan is no longer straight but rather is a stepwise and/or continuous arc of similar sense to one of the base or closure member (the base in the illustrated example). As seen in FIGS. 27 and 30, the angling may render the exemplary thickened portions asymmetric relative to each other. In this example, with an as-molded condition having mating rim portions 332 and 352 coplanar with each other, the hinge mates with one of the base and closure member lower than with the other (e.g., by at least 20%). FIG. 30A shows, along the central portion 522 these respective spacings as S₁₀ and S₁₁ with S₁₁ being at least 120% of S₁₀, more particularly, at least 150% or 150%-300%.

In operation, the tilting or angling serves to bring the snap-open neutral condition closer to the as-molded condition than would a similar un-angled hinge. FIG. 27 shows two pairs of ribs 530A, 530B (collectively or individually 530) and 534A, 534B (collectively or individually 534). The ribs 534 have generally L-shaped configuration with a foot along the hinge underside and a leg along the sidewall of the cover. In this embodiment, there are no similar ribs spanning between the hinge underside and the frame or base. The ribs 530 fall along the underside of the hinge with ends just shy of the respective cover sidewall and frame sidewall.

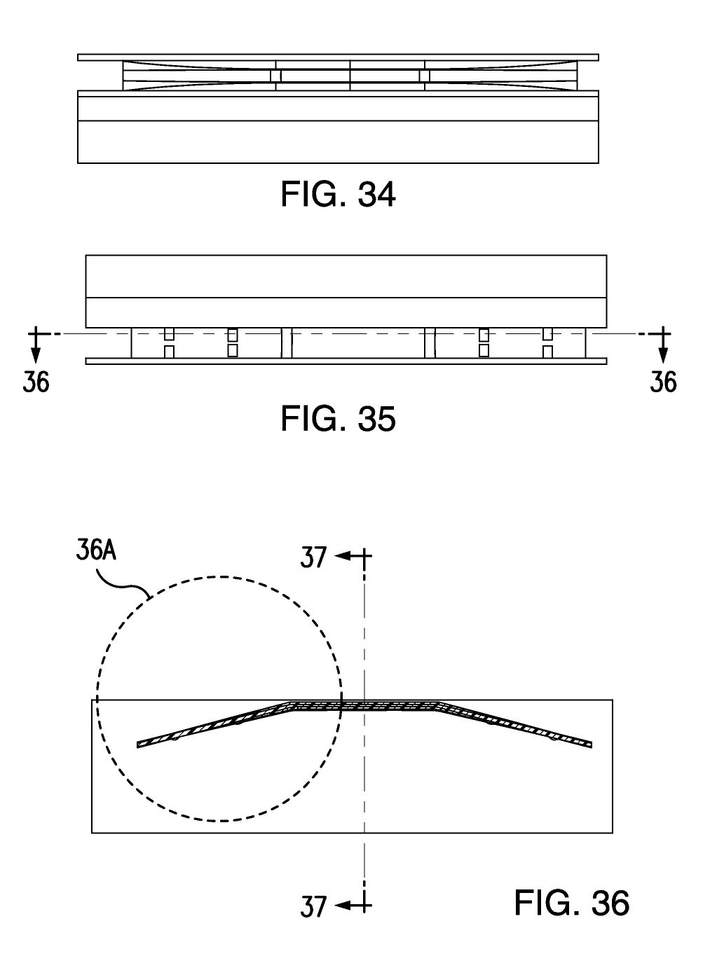

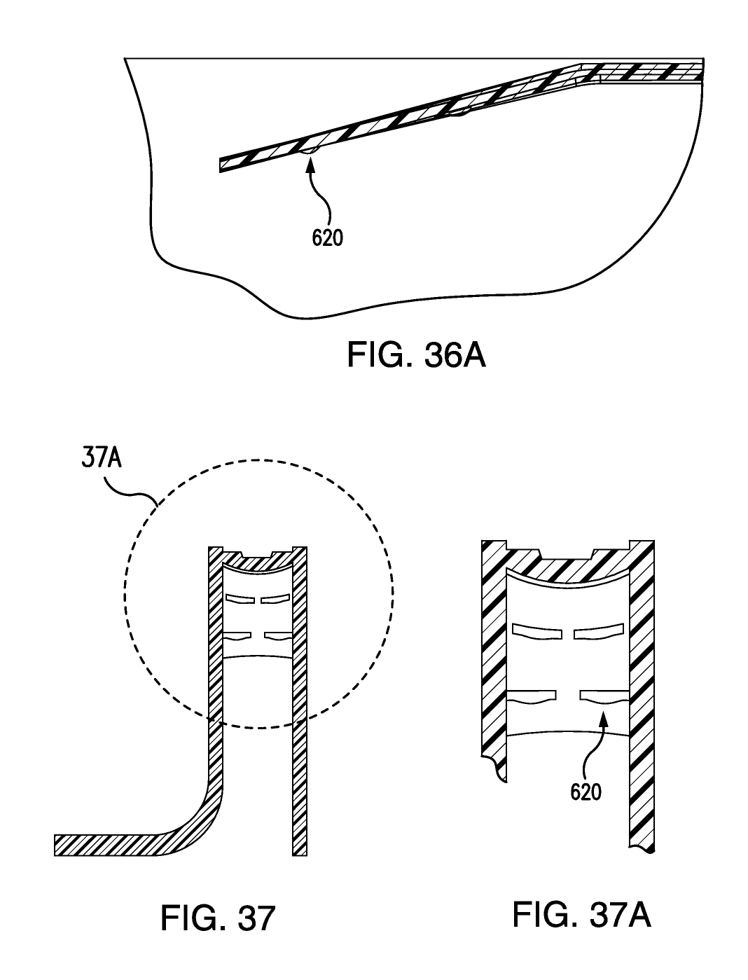

FIGS. 32-37 show a further closure 600 having a hinge 602 connecting a base 604 to a closure member 606. The closure 600 differs from the above closures in one main way: the base 604 and closure member 606 are, at least along the span of the hinge, of straight planform. This might, for example, be the case where the overall planforms of base and closure member are generally rectangular with rounded corners as is often the case with tub-type containers. In this embodiment, reinforcements are located along the hinge underside in approximate similar fashion to those the FIG. 13 embodiment.

Exemplary closure material is a molded plastic such as a conventional polypropylene or copolymerpolypropylene (CoPP).

The use of “first”, “second”, and the like in the description and following claims is for differentiation within the claim only and does not necessarily indicate relative or absolute importance or temporal order. Similarly, the identification in a claim of one element as “first” (or the like) does not preclude such “first” element from identifying an element that is referred to as “second” (or the like) in another claim or in the description.

Where a measure is given in English units followed by a parenthetical containing SI or other units, the parenthetical's units are a conversion and should not imply a degree of precision not found in the English units.

One or more embodiments have been described. Nevertheless, it will be understood that various modifications may be made. For example, when applied to an existing basic system, details of such configuration or its associated use may influence details of particular implementations. Accordingly, other embodiments are within the scope of the following claims.

What is claimed is:

1. A system (200; 300; 400; 500; 600) comprising the unitarily molded single-piece combination of:
a first portion (204; 304; 404; 504; 604);
a living hinge (202; 302; 402; 502; 602); and
a second portion (206; 306; 406; 506; 606) coupled by the living hinge to the first portion and shiftable between a first condition and second condition via rotation about the living hinge,
wherein the living hinge comprises:
a first end (80) at the first portion;
a second end (82) at the second portion; and
between the first end and the second end:
a central portion;
first and second lateral portions;
a first face (88); and
a second face (90), at least one of the first face and the second face bearing a plurality of ribs (220, 222; 320; 430, 432, 434; 530, 534; 620).

2. The system (200, 400; 500) of claim 1 wherein:
the plurality of ribs include one or more ribs (220, 222; 432, 434; 534) spanning a junction with at least one of the first portion and the second portion.

3. The system (200) of claim 2 wherein:
the one or more ribs comprise a first plurality (220) spanning a junction with the first portion and a second plurality (222) spanning a junction with the second portion, the first and second pluralities being staggered relative to each other.

4. The system (400) of claim 1 wherein:
the lateral portions have curvature between the first and second ends opposite a curvature of the central portion.

5. The system of claim 1 wherein:
the first portion is a mounting base having an aperture (30);
the second portion is a cap;
the first condition is a closed condition;
the second condition is an open condition.

6. The system of claim 5 wherein:
spring bias of the living hinge will maintain the hinge in the open condition

7. The system of claim 5 wherein:
the base is internally threaded (36);
the cap, in the closed condition, surrounds and covers an upper rim portion of the base and has a detented engagement therewith.

8. The system of claim 5 wherein:
the second condition is a relaxed condition; and
the combination is molded of polypropylene.

9. The system of claim 1 wherein:
in the as-molded condition, a proximal-to-distal median of the hinge is generally upwardly concave and downwardly convex along the central portion.

10. The system of claim 1 wherein:
in a closed condition the first face is generally concave in sagittal section and the second face is generally convex in said sagittal section;
in an open condition the first face is generally convex in transverse vertical section and the second face is generally concave in said transverse vertical section; and
in the open condition, the central portion is asymmetrically oriented relative to the base and closure member.

11. The system of claim 10 wherein:
in an as-molded condition the first end and second end are vertically offset from each other.

12. The system of claim 10 wherein:
in an as-molded condition, the central portion is off-symmetric by 5° to 25°.

13. The system of claim 1 wherein:
the plurality of ribs are on an underside one of the first face and the second face but not the other face.

14. A system (200; 300; 400; 500; 600) comprising the unitarily molded single-piece combination of:
a first portion (204; 304; 404; 504; 604);
a living hinge (202; 302; 402; 502; 602); and
a second portion (206; 306; 406; 506; 606) coupled by the living hinge to the first portion and shiftable between a first condition and second condition via rotation about the living hinge,
wherein the living hinge comprises:
a first end (80) at the first portion;
a second end (82) at the second portion; and
between the first end and the second end:
a central portion;
first and second lateral portions;
a first face (88); and
a second face (90), at least one of the first face and the second face bearing means (220, 222; 320; 430, 432, 434; 530, 534; 620) for locally stiffening the hinge.

15. A closure (500) comprising the unitarily molded single-piece combination of:
a base (504) having an opening;
a living hinge (502); and
a closure member (506) coupled by the living hinge to the base and shiftable between a closed condition and an open condition via rotation about the living hinge,
wherein:
the living hinge comprises:
a first end (80) at the base;
a second end (82) at the closure member;
a central portion (522);
first (524) and second (526) lateral portions;
a first face; and
a second face;
in the closed condition the first face is generally concave in sagittal section and the second face is generally convex in said sagittal section;
in the open condition the first face is generally convex in transverse vertical section and the second face is generally concave in said transverse vertical section; and
in the open condition, the central portion is asymmetrically oriented relative to the base and closure member.

16. The system of claim 15 wherein:
in an as-molded condition the first end and second end are vertically offset from each other.

17. The system of claim 15 wherein:
in an as-molded condition, the central portion is off-symmetric by 5° to 25°.

18. The system of claim 15 wherein:
in the as-molded condition, a proximal-to-distal median of the hinge is generally upwardly convex along a central portion.

19. The system of claim 15 wherein:
at least one of the first face and the second face bears a plurality of ribs.

20. A method for manufacturing the system of claim 15 comprising injection molding in the as-molded condition.
